(19) United States
(12) Patent Application Publication
(10) Pub. No.: US 2020/0241541 A1
(43) Pub. Date: Jul. 30, 2020

(54) SYSTEM AND METHOD OF AN ALGORITHMIC SOLUTION TO GENERATE A SMOOTH VEHICLE VELOCITY TRAJECTORY FOR AN AUTONOMOUS VEHICLE WITH SPATIAL SPEED CONSTRAINTS

(71) Applicant: GM GLOBAL TECHNOLOGY OPERATIONS LLC, Detroit, MI (US)

(72) Inventors: Travis R. McCawley, Berkeley, CA (US); Jeffrey J. Waldner, New Hudson, MI (US)

(73) Assignee: GM GLOBAL TECHNOLOGY OPERATIONS LLC, Detroit, MI (US)

(21) Appl. No.: 16/259,935

(22) Filed: Jan. 28, 2019

(51) Int. Cl. G05D 1/02; G05D 1/00

(52) U.S. Cl. CPC G05D 1/0217; G05D 1/0088

(57) ABSTRACT

Methods and systems for piecewise sinusoid trajectory planning including: receiving, by a processing unit disposed in an ego vehicle, point data defining a current path plan for the ego vehicle; fetching, by the processing unit, a current ego position along the current path plan; calculating, by the processing unit, a current velocity and an acceleration for the current ego position which is based in part on a velocity and acceleration derived from a previous planned trajectory, the planned trajectory is calculated by: setting a graph with a grid of nodes in the velocity-time domain of the search space connected by edges; evaluating the graph with a shortest path algorithm wherein the validity and cost with respect to desired constraints of vehicle motion and system limitations of each edge are determined by use of the piecewise sinusoidal path length, velocity, and acceleration profiles which are parameterized to connect pairs of nodes; setting, by the processing unit, the optimal vehicle trajectory equal to the set of connected edges, and thereby piecewise sinusoid velocity profiles, which minimize the objective cost function over some duration planned into the future.

### BACKGROUND

The technical field generally relates to an autonomous vehicle motion planning system and method, and more particularly relates to a system and method for trajectory planning for a controlled time gap spacing when following a vehicle by an autonomous vehicle by using improved trajectory algorithms with spatial speed constraints and vehicle dynamic parameterized limitations.

Vehicle platooning is a feasible solution of driving control for connected autonomous or semi-autonomous vehicles that can enable significant fuel savings when the vehicles are arranged in a convoy where the longitudinal spacing is maintained between the vehicles due to a slip stream effect. The use of automated motion planning applications can assist and simplify vehicle control for forming vehicle platoons. The motion planning by autonomous or semi-autonomous vehicle includes control operations of finding a path, (2) searching for the safest maneuver and (3) determining the most feasible velocity trajectory. The component of trajectory planning is the real-time planning of the actual vehicle's transition from one feasible state to the next, based on vehicle dynamics and constraints of acceleration (lateral & longitudinal), the curvature of the trajectory and other parameters. Improved algorithms for planning trajectories are needed for vehicles to follow a lead vehicle and to generate trajectories with constraints to enable consecutive smooth motion trajectories planned during the following process.

Accordingly, it is desirable to provide systems and methods to improve autonomous or semi-autonomous vehicle algorithmic trajectory planning of a follower vehicle when following a lead vehicle.

Furthermore, other desirable features and characteristics of the present invention will become apparent from the subsequent detailed description and the appended claims, taken in conjunction with the accompanying drawings and the foregoing technical field and background.

### SUMMARY

In an embodiment, a method for piecewise sinusoid trajectory planning is provided. The method includes: receiving, by a processing unit disposed in an ego vehicle, point data defining a current path plan for the ego vehicle; fetching, by the processing unit, a current ego position along the current path plan for a planned trajectory by calculating a velocity and an acceleration for the current ego position which is based in part on a velocity and acceleration derived from a previous planned trajectory; evaluating the planned trajectory using a cost function derived from a plurality of state variables of the ego vehicle to select each adjacent edge wherein each adjacent edge includes: a parameterized sinusoid, the planned trajectory is calculated by: setting, by the processing unit, a path length s of a first node for a current minimum cost solution; calculating, by the processing unit, a time step (Δt) to ensure the resultant path length if added is less than or equal to a path length resolution wherein the path length resolution is the path length distance between each point defined in the ego vehicle path plan with a change in time t₁ and time t₂ wherein time t₁ is a time at a first node and time t₂ equals a sum of the time t₁ and the time step (Δt);

(A) calculating, by the processing unit, an ego vehicle state at a path position s(t₂), a velocity v(t₂) and an acceleration a(t₂) wherein the path position s(t₂) equals the sum of the path length s and a change of path length (Δs);
(B) fetching, by the processing unit, a set of a plurality of path parameter of friction μ(s), grade θ(s) and curvature k(s);
(C) validating, by the processing unit, a set of a plurality of constraint checks of limits of dynamics and behavior of the ego vehicle;
(D) calculating and integrating, by the processing unit, sub-costs of a discretized cost function for planning the trajectory wherein the sub-costs include: time gap error and follow distance error costs between time t₁ and time t₂;
determining, by the processing unit, if the time t₂ is less than a time t_{b} at a second node, if so then setting time t₁ to time t₂ and repeating steps (A) to (D), if not then calculating the sub-costs with a closed form solution of the cost function for entire edge wherein the sub-costs include: acceleration error costs for an entire edge; and calculating, by the processing unit, the total edge costs by summing all the sub-costs wherein the total edge costs include: time gap cost, acceleration cost, and follow distance cost.

In various exemplary embodiments, the method further includes: creating, by the processing unit, a node grid in a velocity-time domain wherein the node grid includes: at least one of a first node, at least one of a second node, and at least one of an adjacent edge wherein the first node is coupled to the second node by the adjacent edge wherein the adjacent edge includes a parameterized sinusoid velocity profile of a half period to connect the first and second nodes' velocities; resetting, by the processing unit, parameters of the adjacent edge wherein the parameters include: a minimum cost and a path length (Δs) of edge; and resetting, by the processing unit, parameters of the first and second nodes wherein the parameters include: minimum cost, parent node, and path length s. The further includes: updating, by the processing unit, the first node with the velocity v(t₀,), acceleration a(t0), and the path position s(t₀) to determine the current minimum cost solution. The method, further includes: parameterizing and validating, by the processing unit, the adjacent edge for use as a starting edge to determine the current minimum cost path solution. The method, further includes: executing a shortest path algorithm on a graph of the node grid for a set of items including: at least one first node, at least one second node and at least one adjacent edge to calculate a cost for each item of the set based on the current minimum cost solution.

The method, further includes: generating, by the processing unit, an optimal trajectory based on the minimum cost solution and by using a piecewise sinusoidal function to determine the velocity v(t) and acceleration a(t) for the planned trajectory.

The method, further includes: generating, by the processing unit, the cost function which includes: a total cost function of: Jₜₒₜ=J_{T}+Jₐ+J_{d} and instantaneous time gap:

$$TG ( t ) = \frac{{s}_{L} ( t ) - s ( t )}{v ( t )}$$

wherein J_{T}=∫ₜ_{₁}^{t}^{₂}C_{JT}(TG_{des}−TG(t))²dt and Jₐ=∫ₜ_{₁}^{t}^{₂}a(t)²dt=¼C_{Ja}A²ω[2ω(t₂−t₁)+sin(2(ωt₁+ϕ))−sin(2(ωt₂+99 ))] and J_{d}=∫ₜ_{₁}^{t}^{₂}C_{Jd}(d_{soft}−d(t))²dt.

The cost function includes: J_{Rem}=∫ₜ_{₂}^{t}^{_{f}}(TG_{des}−TG(t)|_{ν}_{_{F}}_{(t)=ν}_{₂}_{, ν}_{_{L}}_{(t)=ν}_{_{Li}})²dt for a heuristic cost with A* shortest path algorithm wherein ν₂=ν(t₂), s₂=s(t₂), and s_{L2}=s_{L}(t₂). The cost function includes:

$${J}_{Rem} ( {t}_{2} , {t}_{f} ) = ( {t}_{LA} - {t}_{2} ) {( {TG}_{des} - \frac{{s}_{L 2} - {s}_{2} + {t}_{2} ( {v}_{2} - {v}_{Li} )}{{v}_{2}} )}^{2} + \frac{( {t}_{LA}^{3} - {t}_{2}^{3} ) {( {v}_{2} - {v}_{Li} )}^{2}}{3 {v}_{2}^{2}} + \frac{( {t}_{LA}^{2} - {t}_{2}^{2} ) ( {TG}_{des} - \frac{{s}_{L 2} - {s}_{2} + {t}_{2} ( {v}_{2} - {v}_{Li} )}{{v}_{2}} ) ( {v}_{2} - {v}_{Li} )}{{v}_{2}} wherein {v}_{2} = v ( {t}_{2} ) , {s}_{2} = s ( {t}_{2} ) , and {s}_{L 2} = {s}_{L} ( {t}_{2} ) .$$

For edges connected to the node at t=0, the piecewise sinusoidal function includes:

ν(t)=A cos(ωt+ϕ)+β,

$$a ( t ) = - A ω sin ( ω t + φ ) and s ( t ) = \frac{A}{ω} sin ( ω t + φ ) + β t + {s}_{1} wherein ω = \frac{π - φ}{{t}_{2}} , A = \frac{{v}_{1} - {v}_{2}}{cos ( φ ) + 1} , β = {v}_{2} + A ,$$

and ϕ is iteratively solved for using the equation

$$a ( {t}_{0} ) = \frac{( {v}_{2} - {v}_{1} ) ( π - φ ) tan ( \frac{φ}{2} )}{{t}_{2}} .$$

For edges not connected to the node at t=0, the piecewise sinusoidal function includes:

$$v ( t ) = A cos ( ω t + φ ) + β , a ( t ) = - A ω sin ( ω t + φ ) and s ( t ) = \frac{A}{ω} sin ( ω t + φ ) + β t + {s}_{1} wherein ω = \frac{π}{{t}_{2} - {t}_{1}} , φ = - ω {t}_{1} , A = \frac{{v}_{1} - {v}_{2}}{2} , and β = {v}_{2} + A$$

for non-starting edges.

In another embodiment, a system including: a processing unit disposed in an ego vehicle including one or more processors configured by programming instructions encoded on non-transient computer readable media is provided. The processing unit configured to: receive point data defining a current path plan for the ego vehicle; fetch a current ego position along the current path plan for a planned trajectory by a calculated velocity and an acceleration for the current ego position which is based in part on a velocity and acceleration derived from a previous planned trajectory; evaluate the planned trajectory using a cost function derived from a plurality of state variables of the ego vehicle to select each adjacent edge wherein each adjacent edge includes: a parameterized sinusoid; set a path length s of a first node for a current minimum cost solution; calculate a time step (Δt) to ensure the resultant path length if added is less than or equal to a path length resolution wherein the path length resolution is the path length distance between each point defined in the ego vehicle path plan with a change in time t₁ and time t₂ wherein time t₁ is a time at a first node and time t₂ equals a sum of the time t₁ and the time step (Δt);

(A) calculate an ego vehicle state at a path position s(t₂), a velocity v(t₂) and an acceleration a(t₂) wherein the path position s(t₂) equals the sum of the path length s and a change of path length (Δs);
(B) fetch a set of a plurality of path parameter of friction μ(s), grade θ(s) and curvature k(s);
(C) validate a set of a plurality of constraint checks of limits of dynamics and behavior of the ego vehicle;
(D) calculate and integrate sub-costs of a of a discretized cost function for planning the trajectory wherein the sub-costs include: time gap error and follow distance error costs between time t₁ and time t₂ and each sub-cost contains a parameterized sinusoid to connect each node; determine if the time t₂ is less than a time t_{b} at a second node, if so then setting time t₁ to time t₂ and repeating steps (A) to (D), if not then calculating the sub-costs with a closed form solution of the cost function for entire edge wherein the sub-costs include: acceleration error costs for an entire edge; and calculate the total edge costs by summing all the sub-costs wherein the total edge costs includes: time gap cost, acceleration cost, and follow distance cost.

The method further includes: the processing unit configured to: create a node grid for estimated velocities in look ahead time periods wherein the node grid includes: at least one of a first node, at least one of a second node, and at least one of an adjacent edge wherein the first node is coupled to the second node by the adjacent edge; resettable parameters of the adjacent edge wherein the parameters include: a minimum cost and a path length (Δs) of edge; and resettable parameters of the first and second nodes wherein the parameters include: minimum cost, parent node, and path length s. The system, further includes: the processing unit configured to: update the first node with the velocity v(t₀), acceleration a(t₀), and the path position s(t₀) to determine the current minimum cost solution.

The system, further includes: the processing unit configured to: parameterize and validate the adjacent edge for use as a starting edge to determine the current minimum cost solution. The system, further includes: the processing unit configured to: execute a shortest path algorithm on a graph of A* or Dijkstra's on the node grid for a set of items which includes: at least one first node, at least one second node and at least one adjacent edge to calculate a cost for each item of the set based on the current minimum cost solution. The system, further includes: the processing unit configured to: generate an optimal trajectory based on the minimum cost solution and by using a piecewise sinusoidal function to determine the velocity v(t) and acceleration a(t) for the planned trajectory.

In yet another embodiment, a vehicle, including a trajectory planner unit including one or more processors and non-transient computer readable media encoded with programming instructions is provided. The trajectory planner unit is configured to: receive point data defining a current path plan for the ego vehicle; fetch a current ego position along the current path plan for a planned trajectory by a calculated velocity and an acceleration for the current ego position which is based in part on a velocity and acceleration derived from a previous planned trajectory; evaluate the planned trajectory using a cost function derived from a plurality of state variables of the ego vehicle to select each adjacent edge wherein each adjacent edge includes: a parameterized sinusoid; set a path length s of a first node for a current minimum cost solution; calculate a time step (Δt) to ensure the resultant path length if added is less than or equal to a path length resolution wherein the path length resolution is the path length distance between each point defined in the ego vehicle path plan with a change in time t₁ and time t₂ wherein time t₁ is a time at a first node and time t₂ equals a sum of the time t₁ and the time step (Δt);

(A) calculate an ego vehicle state at a path position s(t₂), a velocity v(t₂) and an acceleration a(t₂) wherein the path position s(t₂) equals the sum of the path length s and a change of path length (Δs);

(B) fetch a set of a plurality of path parameter of friction μ(s), grade θ(s) and curvature k(s);

(C) validate a set of a plurality of constraint checks of limits of dynamics and behavior of the ego vehicle;

(D) calculate and integrate sub-costs of a discretized cost function for planning the trajectory wherein the sub-costs include: time gap error and follow distance error costs between time t₁ and time t2;

determine if the time t₂ is less than a time t_{b} at a second node, if so then setting time t₁ to time t₂ and repeating steps (A) to (D), if not then calculating the sub-costs with a closed form solution of the cost function for entire edge wherein the sub-costs include: acceleration error costs for an entire edge; and calculate the total edge costs by summing all the sub-costs wherein the total edge costs includes: time gap cost, acceleration cost, and follow distance cost.

The vehicle, further includes: the trajectory planner unit is configured to: create a node grid in the velocity-time domain wherein the node grid includes: at least one of a first node, at least one of a second node, and at least one of an adjacent edge wherein the first node is coupled to the second node by the adjacent edge; resettable parameters of the adjacent edge wherein the parameters include: a minimum cost and a path length (Δs) of edge; and resettable parameters of the first and second nodes wherein the parameters include: minimum cost, parent node, and path length s. The vehicle, further includes: the trajectory planner unit is configured to: update the first node with the velocity v(t₀), acceleration a(t₀), and the path position s(t₀) to determine the current minimum cost path solution. The vehicle, further includes: the trajectory planner unit is configured to: parameterize and validate the adjacent edge to determine the current minimum cost path solution.

### BRIEF DESCRIPTION OF THE DRAWINGS

The exemplary embodiments will hereinafter be described in conjunction with the following drawing figures, wherein like numerals denote like elements, and wherein:

FIG. 1 illustrates a block diagram depicting an example vehicle that may include a processor for generating trajectories for a trajectory planning system in accordance with an exemplary embodiment;

FIG. 2 illustrates a diagram of a grid of nodes and edges in a time-velocity domain for use as a graph to balance costs of the trajectory planner system in accordance with an exemplary embodiment;

FIGS. 3A, 3B and 3C illustrate diagrams for each piecewise sinusoidal function in both the temporal and spatial domains and costs in a graph used to construct a trajectory of the trajectory planner system in accordance with an exemplary embodiment;

FIG. 4 illustrates a flowchart of a trajectory planner process for parameterizing the temporal search space graph with sinusoidal trajectories of the trajectory planner system in accordance with an exemplary embodiment;

FIG. 5 illustrates a flowchart of a process for determining edge cost/validity of the trajectory planner system in accordance with an exemplary embodiment;

FIG. 6 illustrates a flowchart of another process for determining edge cost/validity of the trajectory planner system in accordance with an exemplary embodiment;

FIG. 7 illustrates a diagram of the path planner connected to the trajectory planner that generates the longitudinal trajectory plan for the vehicle control of the trajectory planner system in accordance with an embodiment; and

FIG. 8 illustrates a flowchart of a trajectory planner overall runtime process of the trajectory planner system in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

Autonomous and semi-autonomous vehicles are capable of sensing their environment and navigating based on the sensed environment. Such vehicles sense their environment using multiple types of sensing devices such as radar, lidar, image sensors, and the like. In such vehicles the sensed data can be fused together with map data to process the spatial path plan into a temporal velocity plan which the low-level controllers will execute.

The trajectory planning or generation for an autonomous vehicle can be considered as the real-time planning of the vehicle's transition from one feasible state to the next, satisfying the vehicle's limits based on vehicle dynamics and constrained by the navigation lane boundaries and traffic rules, while avoiding, at the same time, obstacles including other road users as well as ground roughness and ditches.

The trajectory plan can be optimized by using a cost function according to a dynamic model and/or the presence of obstacles along that trajectory to enable the smooth continuous vehicle trajectory. The trajectory planning is parameterized by time and enables a trajectory selected that will provide a profile which yields a time gap between the ego and forward vehicle to as close as feasible to the desired time gap. This yields a natural following behaviour which adapts based on speed (higher vehicle speed leads to larger follow distance) and will keep the ego vehicle at a safe follow distance at all points in time.

In addition, after finding the best path to follow and the best maneuver to undertake, a trajectory planner process must satisfy a motion model or set of state constraints to guarantee a level of comfort for passengers in the autonomous vehicle and smoothness in consecutive states of each subsequent trajectory that are planned which is executable by the lower level controllers and actuators. Hence, when generating a trajectory plan, in accordance with each path and maneuver selected, an optimized cost function is realized by planning piecewise sinusoid velocity profiles in a graph such that the resultant set of piecewise sinusoid velocity profiles selected satisfies constraints that can assure smooth motion for the autonomous vehicle through the road network.

In various exemplary embodiments, the present disclosure describes systems and methods for overcoming obstacles of trajectory planning by implementing a trajectory generating model that 1) selects piecewise sinusoidal functions to construct the trajectory, 2) prioritizes or orders a set of path/vehicle dynamic limitations when generating the trajectory, 3) implements an unconventional use of a shortest path algorithm by searching in the velocity/time domain, 4) uses computationally efficient cost functions and heuristic cost functions to evaluate trajectory sections and to select trajectories which maintain a desired time gap with a pleasing operation, 5) provides an ability of a trajectory planner to be paired with a low level controller frequency response analysis which grants the ability to reject unstable trajectories before being realized by the controller, and 6) applies a derivative (acceleration) matching solution of a starting node with a previous trajectory to ensure continuity between consecutive trajectories.

In various embodiments, a system and method to improve autonomous or semi-autonomous vehicle algorithmic trajectory planning of a follower ego vehicle when following a lead vehicle by using piecewise sinusoidal functions to construct vehicle trajectories and by efficiently balancing path costs and vehicle dynamic constraints when planning each trajectory is disclosed.

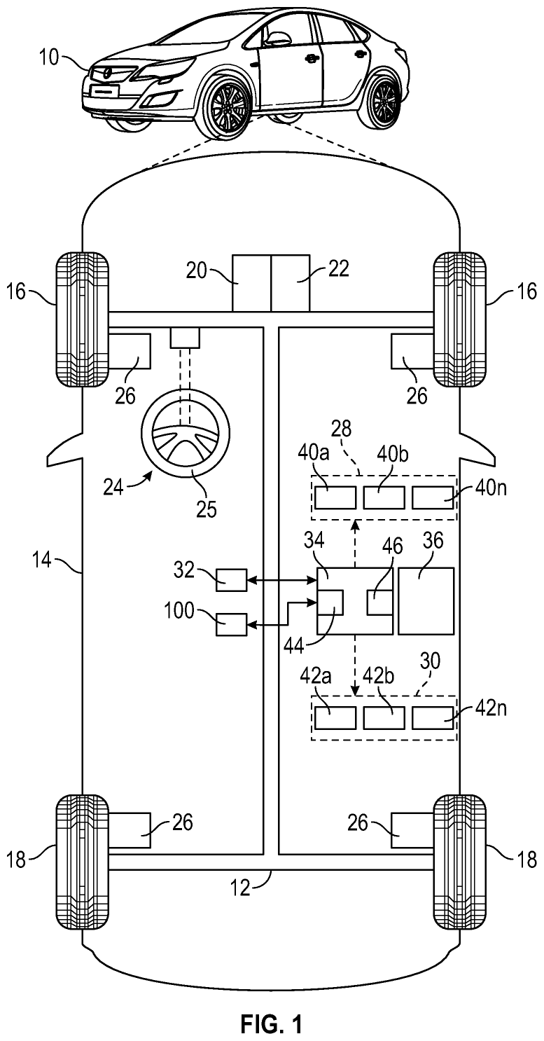

FIG. 1 illustrates a block diagram depicting an example vehicle that may include a processor that implements a vehicle trajectory planner system 100 (or simply “system”) 100. In general, mapping data is fused into the system. The system 100 determines a position of moving target vehicles while aligning with the road geometry using map data and while taking into account vehicle dynamics and constraints.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The vehicle wheels 16-18 are each rotationally coupled to the chassis 12 near a respective corner of the body 14. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in this example, includes an electric machine such as a permanent magnet (PM) motor. The transmission system 22 is configured to transmit power from the propulsion system 20 to the vehicle wheels 16 and 18 according to selectable speed ratios.

The brake system 26 is configured to provide braking torque to the vehicle wheels 16 and 18. Brake system 26 may, in various exemplary embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some exemplary embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10 and generate sensor data relating thereto.

The actuator system 30 includes one or more actuator devices 42a-42n that control one or more vehicle features such as, but not limited to, the propulsion system 20, the transmission system 22, the steering system 24, and the brake system 26. In various exemplary embodiments, the vehicle 10 may also include interior and/or exterior vehicle features not illustrated in FIG. 1, such as various doors, a trunk, and cabin features such as air, music, lighting, touch-screen display components, and the like.

The data storage device 32 stores data for use in controlling the vehicle 10. The data storage device 32 may be part of the controller 34, separate from the controller 34, or part of the controller 34 and part of a separate system.

The controller 34 includes at least one processor 44 (integrate with system 100 or connected to the system 100) and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals (e.g., sensor data) from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

As an example, the system 100 may include any number of additional sub-modules embedded within the controller 34 which may be combined and/or further partitioned to similarly implement systems and methods described herein. Additionally, inputs to the system 100 may be received from the sensor system 28, received from other control modules (not shown) associated with the vehicle 10, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

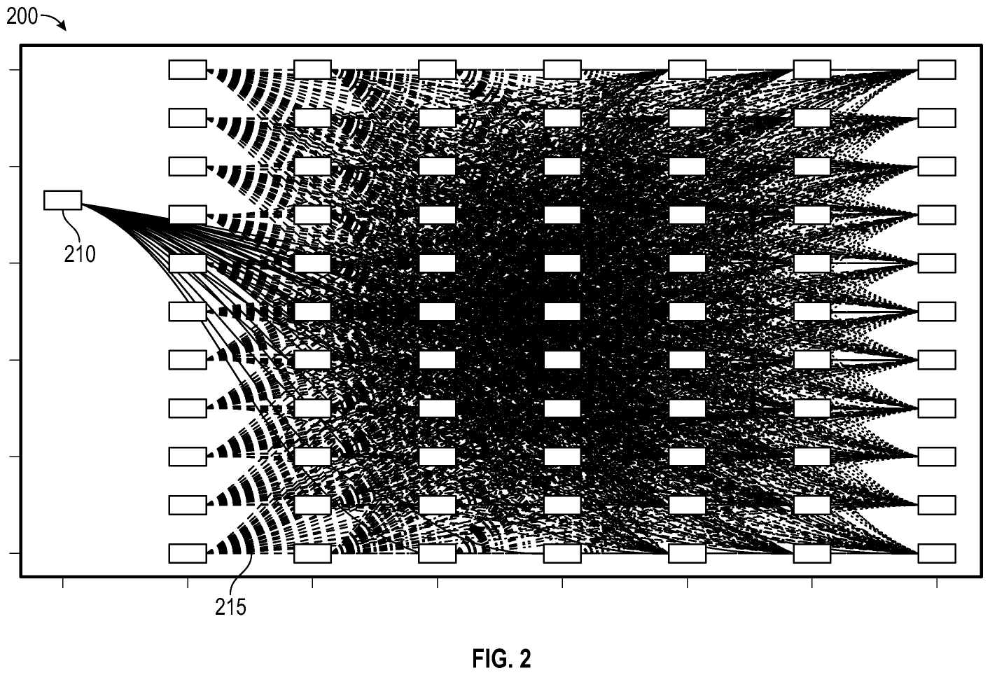

FIG. 2 illustrates a grid of nodes and edges for use as a graph 200 to balance costs by the trajectory planner system in accordance with an embodiment. The graph 200 is a weighted network in a time and velocity domain for searching in a time domain a minimum cost path with a node set N, and an edge set E and a weighting or cost set C specifying costs (Nᵢ, Nⱼ) to determine the minimum cost path from first node “S” to the other nodes in the grid. In an exemplary embodiment, Dijkstra's algorithm (or A*) may be used to find the minimum cost path. As a point of clarity, A* and Dijkstra's algorithms are each separate shortest path algorithms. The A* algorithm can be considered a generalized version of Dijkstra's algorithm with the addition of a heuristic cost. If the heuristic cost can be determined, then A* algorithm can generate a better result. When using Dijkstra's algorithm, the heuristic cost is set at zero. In addition, a graph can be considered a data structure by which each of the algorithms (i.e. A* and Dijkstra) can operate.

Alternative applicable algorithms that may also be configured for minimum cost (shortest) path solutions include: Bellman-Ford and Floyd-Warshall algorithm. The former is applicable to paths with arbitrary costs, and the latter is applicable to arbitrary costs and generalized all-to-all shortest path. Both are distinguishable from Dijkstra's algorithm in that on graphs of each there is no negative costs applied for the shortest path formulations. That is, the Dijkstra based solution finds the shortest path balancing negative costs, i.e., Cij≥0 for all the nodes in the grid (Nᵢ, Nⱼ) ∈ E. Hence, by using the Dijkstra's algorithm, the trajectory planner system 100 can automatically find a minimum cost path connecting two nodes, such as driving directions on using for example location points of maps from mapping applications. Therefore, by using Dijkstra's algorithm, the trajectory planner system 100 can find the minimum cost (shortest) path from a starting or current node to other nodes in the grid optimally by balancing negative costs and not relying on arbitrary cost models.

The initial node S 210 is the starting node at current time and vehicle velocity or a current node of the vehicle trajectory that is input to the trajectory planner system. Initially, the trajectory planner system 100 initializes the graph 200 defined by time and velocity with zero cost, zero path length, and NULL parent node. Each pair of nodes is connected with an edge that contains a parameterized sinusoid of one half period connecting the nodes. The parameterized sinusoid is evaluated for validity against nominal vehicle dynamic limits. The edge is also initialized with a zero cost and zero path length change. The initial parameters of the graph can be reset to zero/NULL and calculated for each new trajectory plan. For each execution loop, the algorithm will solve for a minimum cost (optimal) velocity trajectory by utilizing a shortest path algorithm, like Dijkstra's algorithm, by starting node at an initial node S 210 and then defining the goal node as any node with a final (look ahead) time. The shortest path algorithm operates by iteratively visiting a node, exploring the adjacent edges, selecting the edge which results in minimum cost total path, and visiting the node connected by the selected edge. During the adjacent edge discovery, the trajectory planner algorithm leverages piecewise sinusoidal trajectories to efficiently calculate costs and validity of each edge. Each node by its state, consists of at least the features: min cost, parent, and path length. The path length is a distance value of the node representing a scalar distance estimation of the path length from the starting node S 210 resultant from the current minimum cost trajectory. The current minimum cost trajectory is the ordered sequence of nodes which results in a minimum cost trajectory connecting node S 210 to a goal node. The trajectory planner system 100 updates the states of the nodes in each cycle and relies on the previous trajectory plan to parameterize the current node or start node for the next cycle.

The current node stores the temporary minimum costs and path length of a minimum cost trajectory. Each node 210 realizes a cost (as a result of a shortest path algorithm) based on a change of time and a change of the velocity of the trajectory. In the process, based on the state of the vehicle, the trajectories between an initial and desired goal states are searched for in the node grid that is adapted for on road motion planning, such that only states that are a priori likely to be in the solution are represented. The possible trajectories are evaluated by an A*/Dijkstra cost function that considers the vehicle dynamic, environmental and behavioral constraints.

In the process, the initial values of minimum cost, path length, velocity, and acceleration are reset. The subsequent node can be defined by data structures that include: the node ID, the time, vehicle velocity, vehicle acceleration, the minimum cost required to get to the node, the ID of the parent required to achieve the minimum cost, the current path length required to get to this node at the minimum cost trajectory, the current estimated follow distance achieved at the minimum cost trajectory, and the current estimated time gap achieved at the minimum cost trajectory. In this context “current” relates to the time identified by the given node.

The trajectory function definition and validity are updated with respect to the connected nodes (edges). The peak acceleration is the maximum acceleration of a trajectory sinusoid piecewise function. An edge is determined invalid if the peak acceleration would violate nominal longitudinal comfort acceleration limits. An edge is determined valid if the peak acceleration satisfies the comfort level for the vehicle operation. Additionally, the trajectory planner system 100 checks for nominal longitudinal vehicle dynamics limits with consideration of hardware constrains with some factor of safety.

The trajectory planner system 100 uses parameterized piecewise sinusoidal trajectories. A benefit of such a trajectory is the ability to reject trajectories based on instable frequencies determined by offline controller frequency response analysis. The cost function equations are based on a time gap error, a follow a distance error, and an acceleration error. The order of a vehicle dynamic limit checks and path constraint checks are optimized by the trajectory path planner system 100.

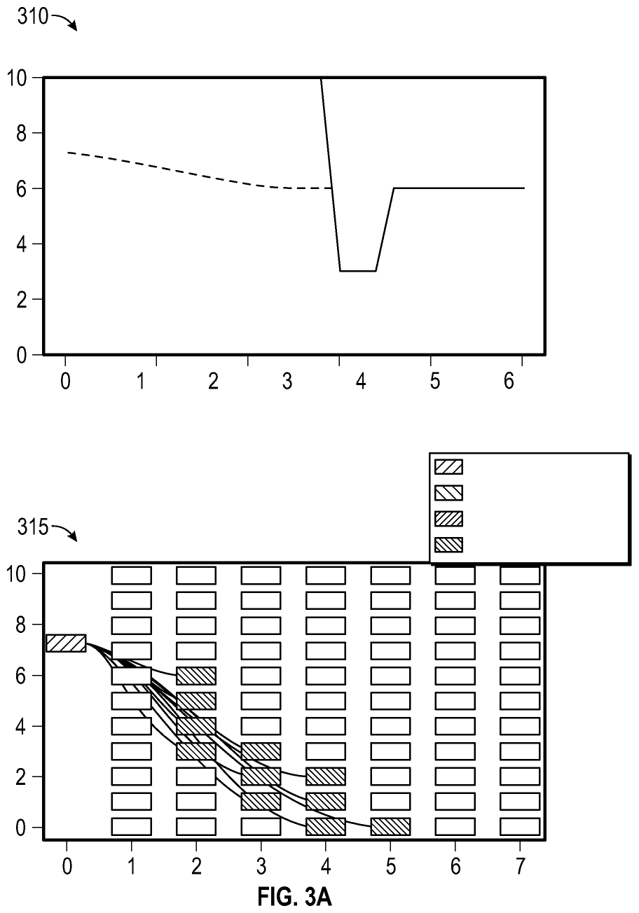

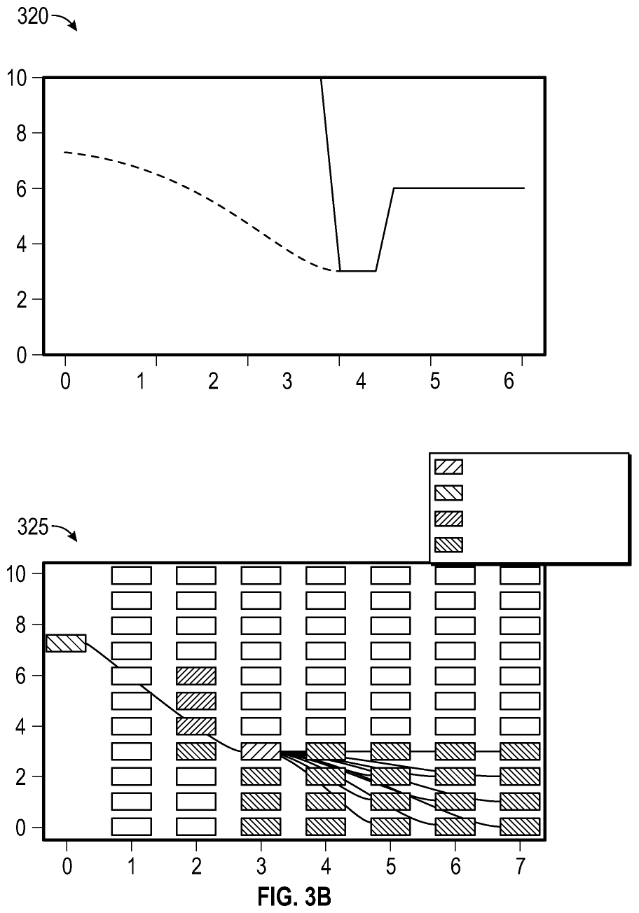

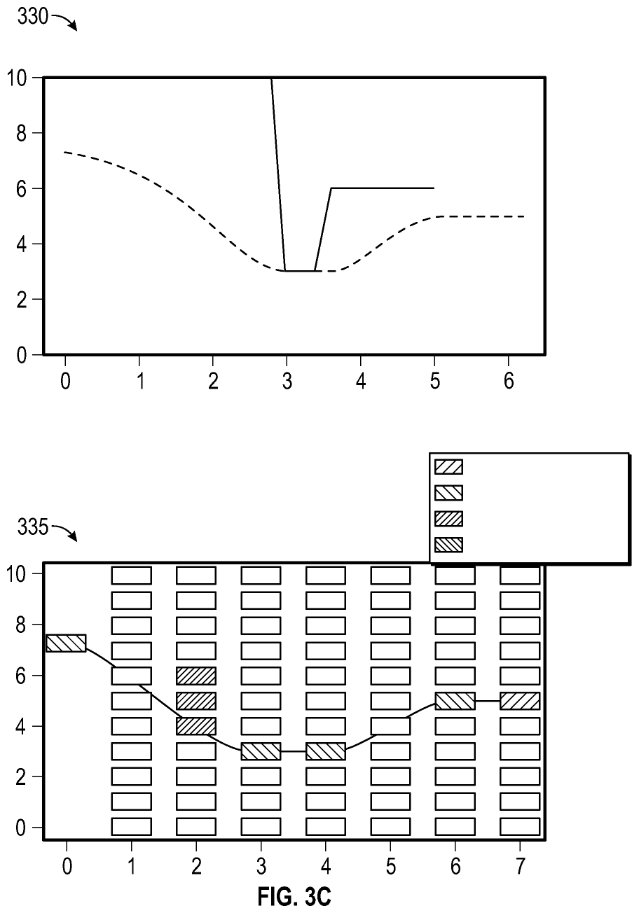

FIGS. 3A, 3B and 3C illustrates a diagram for subsequent steps of the execution of a shortest path algorithm to identify each piecewise sinusoidal function to construct a trajectory for the trajectory planner system 100 in accordance with an embodiment.

The piecewise sinusoidal functions are represented in graphs 310, 320 and 330 which are each constructed by calculations from a trajectory function and a defined sinusoidal piecewise function that enables the trajectory planner system to calculate and store parameters and equations of velocity, acceleration, and path length as a function of time. The graphs 310, 320, and 330 are representations of the solved trajectory in the spatial domain, that is, velocity-path length, which showcases this method's ability to plan around a spatially defined velocity restriction.

Each of the graphs 315, 325, and 335 uses the sinusoidal Piecewise functions:

$$\begin{matrix}v ( t ) = A cos ( ω t + φ ) + β & ( 1 ) \\ a ( t ) = - A ω sin ( ω t + φ ) & ( 2 ) \\ s ( t ) = \frac{A}{ω} sin ( ω t + φ ) + β t + {s}_{1} & ( 3 ) \\ - ∞ < A < ∞ , ω > 0 , 0 \leq φ \leq \frac{π}{2} , 0 \leq β < ∞ & ( 4 )\end{matrix}$$

The optimally selected nodes of the grid of nodes 315, 325 and 335 define the connected generated piecewise sinusoidal velocity trajectory as a function of time. This trajectory corresponds to the path position as a function of time in graphs 310, 320 and 330. Each highlighted node and adjacent edges represented in the grid of nodes 315, 325 and 335 are a representation of the optimal path for each piecewise sinusoid that can be used to construct a new trajectory.

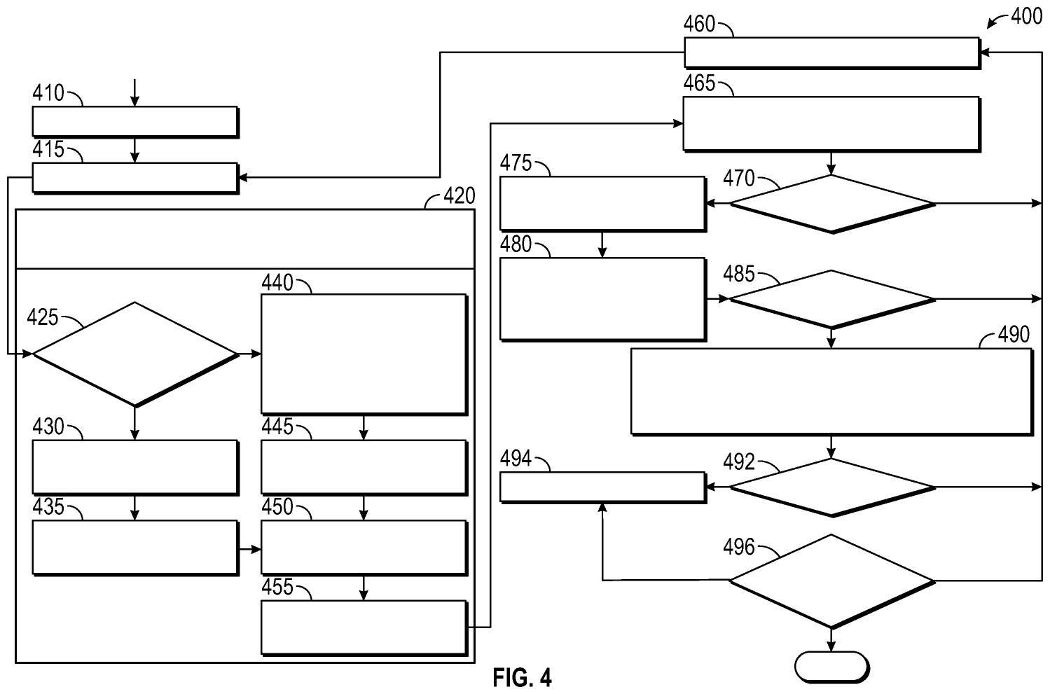

FIG. 4 illustrates a flowchart of a trajectory planner process that uses a temporal search space for generating trajectories of the vehicle speed (i.e. velocity) to time for each subsequent trajectory planned by the trajectory planner system 100 in accordance with an embodiment. The flowchart 400 illustrates at step 410, the trajectory planner process or application steps for generating the initial node grid for each trajectory cost analysis. Next, at step 415, the process flow generates or instantiates a new edge for a next node of a potential shortest path. For each new edge instantiation or generation, a number of sinusoid parameters at 420 are required to be calculated.

In an exemplary embodiment, the functions used to calculate velocity and acceleration based on the input parameters are as follows:

The sinusoidal piecewise section is defined as follows:

$$\begin{matrix}v ( t ) = A cos ( ω t + φ ) + β & ( 1 ) \\ a ( t ) = - A ω sin ( ω t + φ ) & ( 2 ) \\ s ( t ) = \frac{A}{ω} sin ( ω t + φ ) + β t + {s}_{1} & ( 3 ) \\ - ∞ < A < ∞ , ω > 0 , 0 \leq φ \leq \frac{π}{2} , 0 \leq β < ∞ \\ With {t}_{1} \leq t \leq {t}_{2} ( edge time interval ) & ( 4 )\end{matrix}$$

At step 425, the trajectory planner process determines if the new edge is a starting edge. An edge is characterized as starting if it connects two nodes, one of which is defined at t=0. If it is not determined as the starting edge, then at step 430 the process calculates ω for an interval of π with an edge time

$${t}_{1} \leq t \leq {t}_{2} ( edge time interval ) .$$

Subsequently, at step 430, the process calculates ϕ for a desired start time for the particular trajectory. Additionally, other trajectory related parameters are needed to be calculated. That is, the process at step 450 calculates A for the desired velocity change. Alternately, at step 425, if the edge initiated is the starting edge, then at step 440 the process calculates ϕ to achieve a desired current acceleration from a previous trajectory.

At step 455, the process calculates β for the desired end velocity in the trajectory. At step 465, the process checks ω for frequency response stability of low level controllers. If at step 470, the low-level controllers are stable, then at step 475, the peak acceleration −Aω in the trajectory is calculated. If the low-level controllers of the vehicle are not stable, then the process reverts to step 460 and reverts back to reiterate the process flow to determine another possible edge (i.e. starts the cycle again at step 415). Once the peak acceleration −Aω at step 475 is calculated, it is checked at step 480 against comfort limits (i.e. vehicle longitudinal control limits). If the peak acceleration −Aω is determined at step 485 within the comfort limits, then the trajectory planner system 100 checks the peak acceleration at step 490 against nominal vehicle performance at a given speed (i.e. engine torque capability, maximum traction force). Alternately, at step 485, if the peak acceleration −Aω is determined not within the comfort limits then the process reverts to step 460 and re-iterates to the next possible edge. Once, the peak acceleration is determined at step 492 within the nominal vehicle performance capabilities, then an edge at step 494 is added in the node graph to connect with another node. If it is not within the nominal vehicle performance capabilities, then the process reverts to step 460 and re-iterates to the next possible edge. The process continues at step 496, until all the edges have been assessed or explored, and keeps cycling back to step 460 to re-iterate to the next possible edge if all the edges are not completed.

For starting Edges, the constraints:

t₁=0, ωt₂+ϕ=π

ν(t₁)=ν₁, ν(t₂)=ν₂

a(t₁)=a₁, a(t₂)=0

The equations for the edge calculations:

$$\begin{matrix}{a}_{1} = \frac{( {v}_{2} - {v}_{1} ) ( π - φ ) tan ( \frac{φ}{2} )}{{t}_{2}} ⇒ Iteratively solve for φ & ( 5 ) \\ ω = \frac{π - φ}{{t}_{2}} & ( 6 ) \\ A = \frac{{v}_{1} - {v}_{2}}{cos ( φ ) + 1} & ( 7 ) \\ β = {v}_{2} + A & ( 8 )\end{matrix}$$

For the non-starting Edges, the calculations are as follows:

Constraints:

ωt₁+ϕ=0, ωt₂+ϕ=π

ν(t₁)=ν₁, ν(t₂)=ν₂

a(t₁)=0, a(t₂)=0

Equations:

$$\begin{matrix}ω = \frac{π}{{t}_{2} - {t}_{1}} & ( 9 ) \\ φ = - ω {t}_{1} & ( 10 ) \\ A = \frac{{v}_{1} - {v}_{2}}{2} \\ β = {v}_{2} + A & ( 11 )\end{matrix}$$

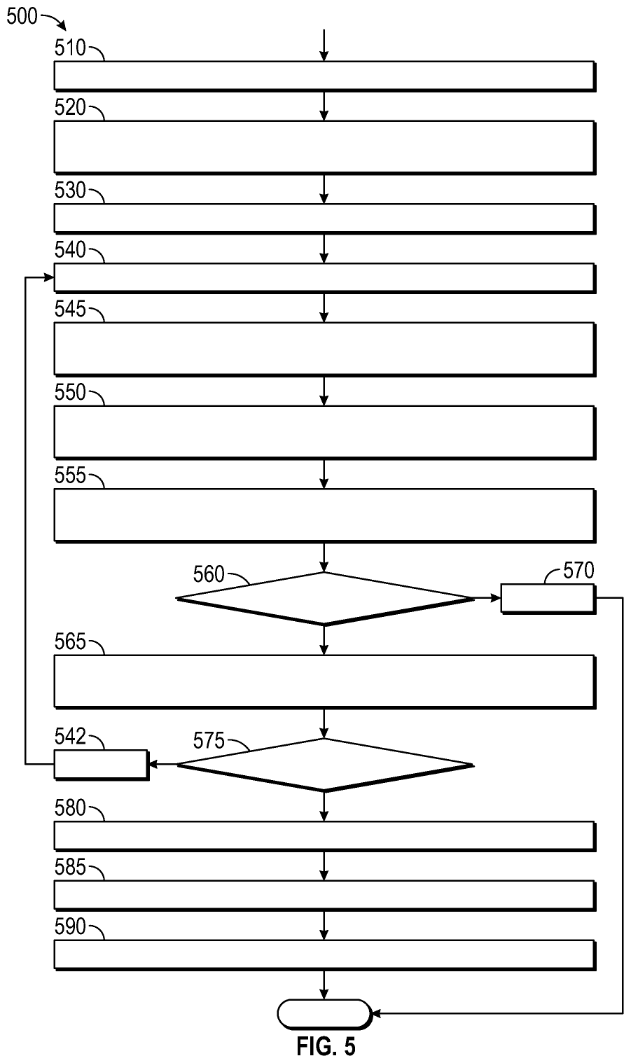

FIG. 5 illustrates a flowchart of determining edge cost/validity executed within a shortest path algorithm for the trajectory planner system 100 in accordance with an embodiment. The flowchart 500 determines the edge cost and validity in a speed and path length domain. In an exemplary embodiment, the validity between a node A and node B path is determined by the trajectory planner system 100.

At step 510, an initial path length S is set as the path length of the node A for a current minimum cost solution. At step 520, the time step (Δt) is calculated to ensure the path length in integration is less than or equal to the path length resolution (Δs). At step 530, t₁ is set to t₁=the time at the node A. At step 540, t₂ is set to t₂=t+Δt. At step 545, the ego vehicle state is calculated as: the path position: s(t₂)=s+Δs, velocity of v(t₂), and acceleration of a(t₂). At step 550, the path parameters are calculated of: friction μ(s), grade: θ(s) and curvature k(s). At step 555, the constraint checks for the vehicle dynamic limits, behavior etc. are performed. At step 560, a determination is made as to whether the constraints check is valid, if it is not invalid at step 570 then no further sub-costs are calculated. If it is valid, then at step 565 the trajectory planner system 100 calculates and integrates sub-costs without the closed form solutions (i.e. a discrete integration). Next at step 575, if t₂ is less than time at node B, t₂<time at node B, then the process iterates back to perform the feedback loop at step 542, and t₁ is set to t₂ (i.e. t₁=t₂) and the process reverts to step 540 in the feedback loop to re-perform the constraint check. Alternately, if t₂>time at node B then the constraint check is deemed valid at step 580 and the system calculates the sub-costs with the closed form solution for the entire edge at step 585. Finally, at step 590, the total edge cost=Σ(sub-costs) is determined.

The cost functions are represented as follows:

Jₜₒₜ=J_{T}+Jₐ+J_{d}

$$TG ( t ) = \frac{{s}_{L} ( t ) - s ( t )}{v ( t )} ,$$

where subscript L indicates forward vehicle parameters

$${J}_{T} = {\int }_{{t}_{1}}^{{t}_{2}} {{C}_{JT} ( {TG}_{des} - TG ( t ) )}^{2} dt$$

$${J}_{a} = {\int }_{{t}_{1}}^{{t}_{2}} {a ( t )}^{2} dt = \frac{1}{4} {C}_{Ja} {A}^{2} ω [ 2 ω ( {t}_{2} - {t}_{1} ) + sin ( 2 ( ω {t}_{1} + φ ) ) - sin ( 2 ( ω {t}_{2} + φ ) ) ]$$

$$d ( t ) = {s}_{L} ( t ) - s ( t )$$

$${d}_{soft} = \{ \begin{matrix}{d}_{max , soft} & {d}_{max , soft} \leq d ( t ) \leq {d}_{max , hard} \\ {d}_{min , soft} & {d}_{min , hard} \leq d ( t ) \leq {d}_{min , soft}\end{matrix} \\ {J}_{d} = {\int }_{{t}_{1}}^{{t}_{2}} {{C}_{Jd} ( {d}_{soft} - d ( t ) )}^{2} dt \\ {J}_{Rem} = {\int }_{{t}_{2}}^{{t}_{f}} {( {TG}_{des} - TG ( t ) {\vert}_{{v}_{F} ( t ) = {v}_{2} , {v}_{L} ( t ) = {v}_{Li}} )}^{2} dt \\ {J}_{Rem} ( {t}_{2} , {t}_{f} ) = ( {t}_{LA} - {t}_{2} ) {( {TG}_{des} - \frac{{s}_{L 2} - {s}_{2} + {t}_{2} ( {v}_{2} - {v}_{Li} )}{{v}_{2}} )}^{2} + \frac{( {t}_{LA}^{3} - {t}_{2}^{3} ) {( {v}_{2} - {v}_{Li} )}^{2}}{3 {v}_{2}^{2}} + \frac{( {t}_{LA}^{2} - {t}_{2}^{2} ) ( {TG}_{des} - \frac{{s}_{L 2} - {s}_{2} + {t}_{2} ( {v}_{2} - {v}_{Li} )}{{v}_{2}} ) ( {v}_{2} - {v}_{Li} )}{{v}_{2}} \\ {v}_{2} = v ( {t}_{2} ) , {s}_{2} = s ( {t}_{2} ) , {s}_{L 2} = {s}_{L} ( {t}_{2} )$$

The priority queue used for the A*/Dijkstra open set is modified so that all nodes along a constant velocity section (all equal cost) will be sorted by ascending time so that nodes are sequentially checked and all branches along it are revealed.

In various exemplary embodiments, the A* heuristic may or will not ensure optimal solutions for the vehicle trajectory planned. To ensure a more optimal solution, the process may revert to Dijkstra's algorithm for balancing costs and defining the shorted trajectory path.

In various exemplary embodiment, lead vehicle velocity predictions are as follows:

$${v}_{L} ( t ) = \{ \begin{matrix}{v}_{min} & {v}_{L} ( t ) \leq {v}_{min} \\ {v}_{Li} + {a}_{Li} t & {v}_{min} \leq {v}_{L} ( t ) \leq {v}_{max} \\ {v}_{max} & {v}_{L} ( t ) \geq {v}_{max}\end{matrix} 0 \leq t \leq {t}_{LA} ( look ahead time ) \\ {s}_{L} ( t ) = {v}_{L} ( t ) t + {s}_{Li} 0 \leq t \leq {t}_{LA} ( look ahead time )$$

The lead vehicle velocity prediction is capped such that if the prediction would exceed the known max/min limits of lead vehicle speed, the velocity prediction will instead return to a constant speed or average speed so as to not overcome the lead constraints. The derivative (acceleration) matching of a starting node is used in order to maintain continuous trajectories from the ego vehicles prior trajectory.

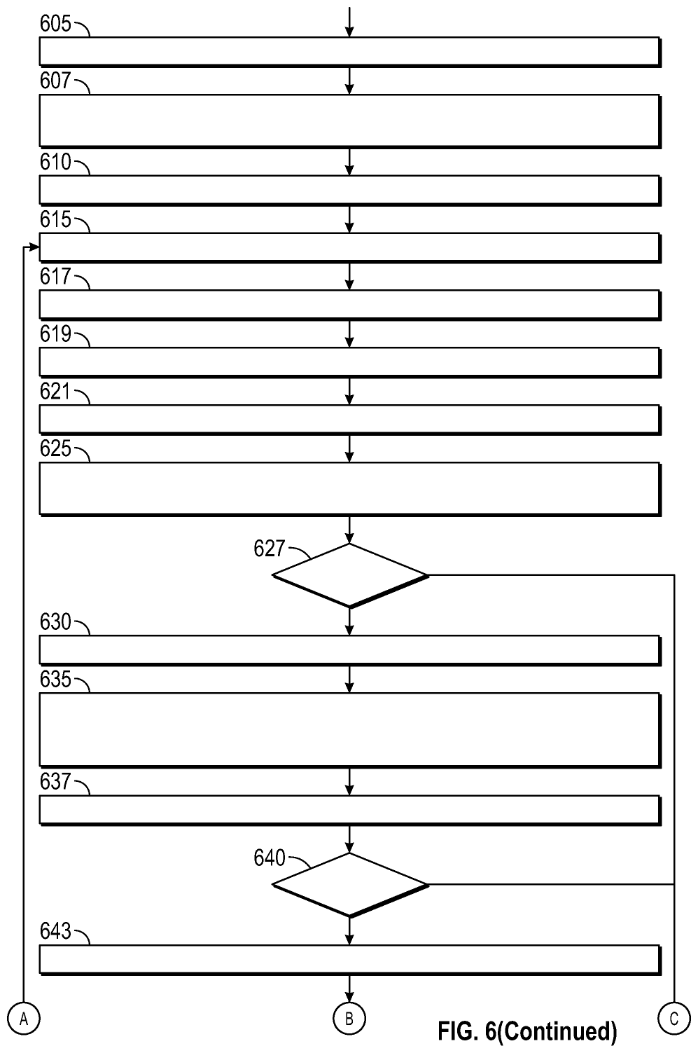

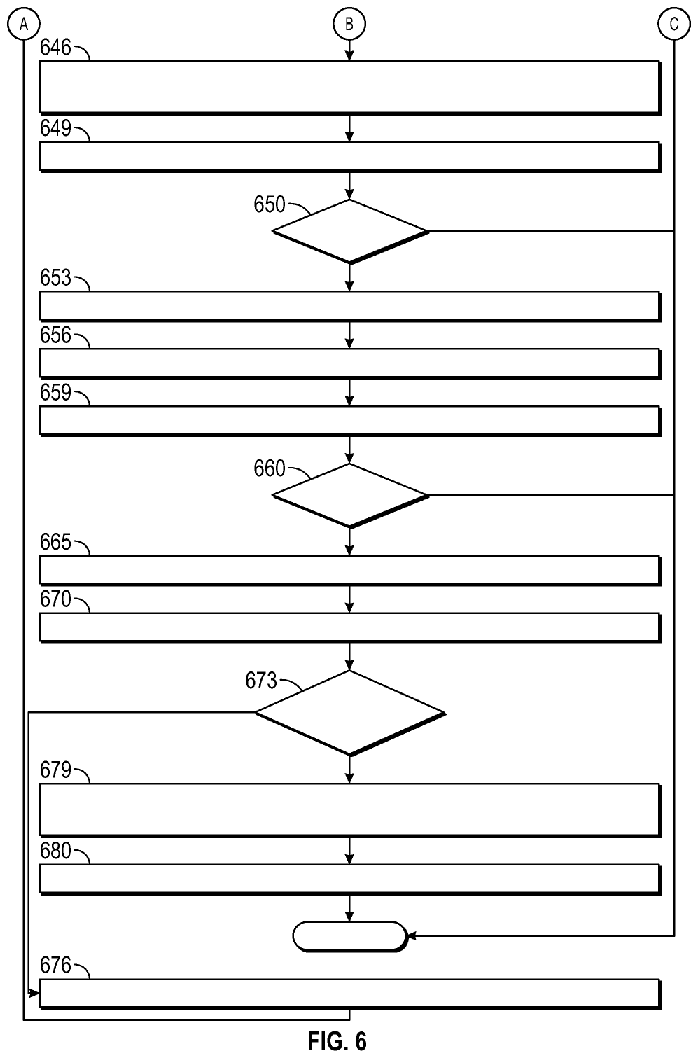

FIG. 6 illustrates a flowchart of another process for determining edge cost/validity executed within a shortest path algorithm for the trajectory planner system in accordance with an embodiment.

In FIG. 6, at step 605, the process defines “s” as the path length that the vehicle has traversed at node A for a current minimum cost solution. The time step (Δt) is calculated at step 607 to ensure the path length when integrated is less than or equal to the path length resolution (Δs). At step 610, the time t₁ is defined for the time at node A. At step 615, the time t₂ is defined at the sum of time t1 and the calculated time step (Δt). At step 617, the leader path length at time t₂ is predicted. A path length resolution (Δs) is defined as the distance between the planned path points of the ego vehicle path. At step 621, the path length “s” of node A is set to the ego vehicle path length change (Δs) summed with the path length “s”. Then at step 625, the distance is checked between the leader and the ego vehicle to determine if it exceeds or violates the min/max following distances, in other words, does not fall within a spacing for the ego vehicle to the lead vehicle. If the distance is valid, then the process proceeds to checking the next constraint; if not, then the process terminates.

At step 630, the ego vehicle velocity at time t₂ is calculated. This is to fetch or get the maximum possible allowed velocity of the path at position “s”. The velocity limit which is set, includes the limit for the maximum possible constant velocity to traverse a curvature of the path at “s”. Next, at step 637, another constraint is checked; that is whether the ego vehicle velocity exceeds an allowed path velocity. If it does at step 640, the process terminates, if not then the next vehicle dynamic constraints are calculated at step 643. The longitudinal acceleration at time t₂ is calculated to get the maximum possible longitudinal acceleration at the path position “s” at step 646. The acceleration is dependent of the grade and surface friction at the path position “s”. Then at step 649, the ego vehicle acceleration is checked to see if it exceeds the possible performance of the ego vehicle. If it is determined at step 650 to not exceed the performance limits, then another constraint is checked. That is at step 653, the ego vehicle total acceleration is calculated at time t₂ and at step 656 the maximum possible traction at path position “s” is determined. Then at step 659, the ego vehicle is checked to see if it exceeds its traction limit. If it is determined at step 660 not to exceed the traction limit, then at step 665, the time gap error cost (jt) is calculated between t₁ and t₂. Then at 670, the distance error cost (jd) is calculated and integrated between t₁ and t₂. If at step 673, t<time at node B then at step 676, t₁ is set to t₂ and the feedback look re-iterates again with t₂ set as t₁ plus a time step Δt. If not, then at step 679, the acceleration cost (ja) for the entire edge time interval is calculated and integrated. Then at step 680, the total edge cost is calculated of j=jt+ja+jd.

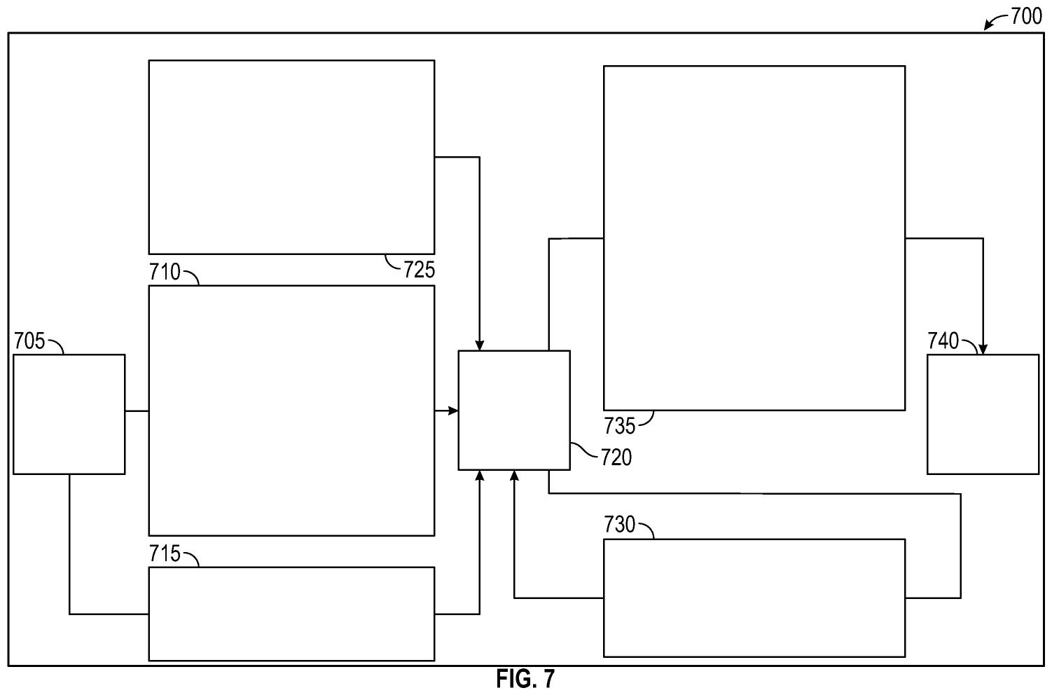

FIG. 7 illustrates an exemplary diagram of the path planner connected to the trajectory planner generating the longitudinal trajectory plan for the vehicle control of the trajectory planner system in accordance with an embodiment.

In FIG. 7, the path planner 705 generates the relative path plan for the vehicle which is composed of discrete points; and the current Ego path length (s). The relative path plan for an <x,y,z> desired path point (i.e. discrete point that follows the planned trajectory) is generated by the following parameters: s path length starting from the Ego vehicle along a path, v speed (i.e. instantaneous velocity v(t)) limit per path point, friction μ(s) per path point, road grade θ(s) per path point and path curvature k(s) per path point. These parameters for each point are received by the trajectory planner 720. In addition, the trajectory planner receives the current Ego path length (s) and the calibratable parameters which include: the cost weighting factors, the hard constraint limits, the soft costing limits, the desired kinetic state goals, the graph density (time/velocity resolution). The Trajectory planner 720 relies on the previous trajectory state 730 of the vehicle velocity and vehicle longitude acceleration to calculate the longitude trajectory plan. The trajectory planner 720 generates a parameterized piecewise longitudinal trajectory (i.e. the longitudinal trajectory plan 735) that is parameterized by: <A, β, ϕ, ω> for each pair of <t,v> nodes selected in the graph, where A is a sinusoid amplitude, β is a sinusoid bias, ϕ is a sinusoid phase shift, ω is a sinusoid frequency. The <t,v> time, velocity are the pairs to which the sinusoids connect. A pair indicates the start and end <time, velocity> for which a given sinusoid is defined. The longitudinal trajectory plan 735 is sent to the longitudinal vehicle control 740.

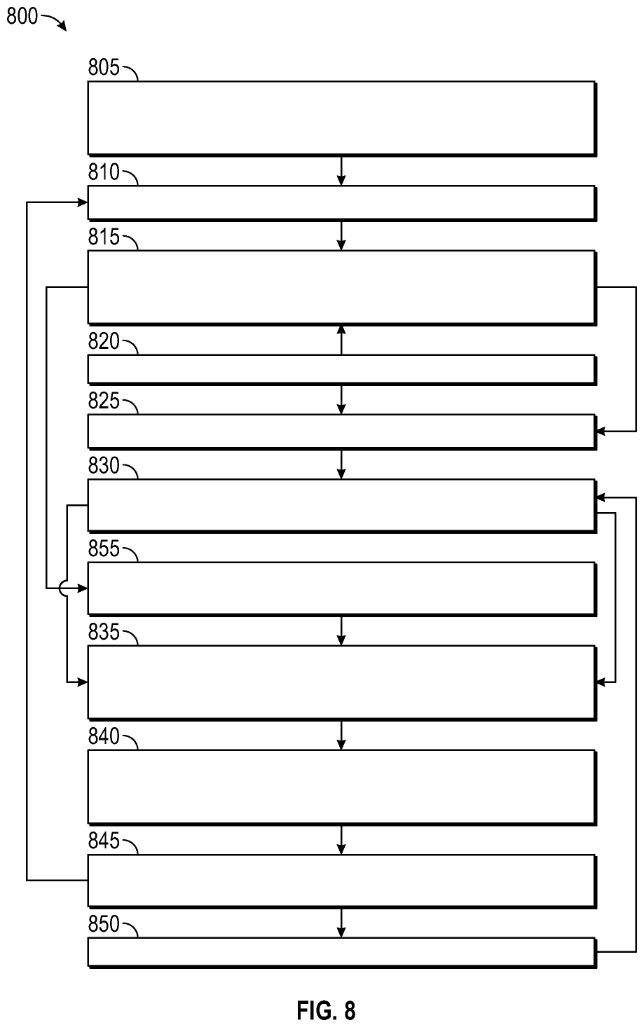

FIG. 8 illustrates a flowchart of is a trajectory planner runtime process flow for the trajectory generator system in accordance with an embodiment.

The flowchart 800 at step 805 initializes the graph by populating all the non-starting (t=0) <time, velocity> nodes and edges. The edge sinusoids are parameterized, and all non-spatial constraints are checked. At step 810, the run time loop 810 is initialized. At step 815, the new relative path plan is received based on the path plan 820 input for a set of path points that originate from the ego vehicle and that define the path with the parameters of grade, friction, curvature, speed limit etc. Next, at step 825, the current ego vehicle position along a current path plan is extracted or fetched with input from the path plan 820; and in conjunction, at step 855, the edge and nodes are reset. The edge parameters of minimum cost and path length A or change, and the node parameters of minimum cost, parent, and path length are all reset or initialized. In a concurrent manner, at step 830 the vehicle desired velocities and acceleration are calculated from the previous trajectory plan (for a seamless continuum of the trajectory plan). Next, from inputs from step 855 of the reset of the edges and nodes and the desired velocities and accelerations of step 830, an update of the first node at step 835 is performed. The update at step 835 consists of updating the first node with the current velocity, acceleration and path length position, and parameterizing and validating the starting edges. Next, at step 840 the shortest path algorithm (A*/Dijkstra's) executes on the graph wherein each node is processed to fetch valid adjacent edges and to calculate the cost given the current cost path. The solution to the shortest path algorithm is the optimal velocity trajectory. Then at step 845, the new trajectory plan is output and stored 850 with the piecewise sinusoidal velocity and acceleration as a function of time. The cycle is either ended or a new loop is instigated at 810. In subsequent cycles, the previously generated trajectory plan output from step 845 is in a feedback loop sent as an input for the trajectory planner at step 830 for basing the next new trajectory plan.

The various tasks performed in connection with supervised learning and training of the depth estimation model may be performed by software, hardware, firmware, or any combination thereof. For illustrative purposes, the following description of depth image generation, image reconstruction, camera-based depth error calculation, radar based range estimation, doppler based range estimation, radar based depth error calculation, doppler based depth error calculation, global loss calculations etc. may refer to elements mentioned above in connection with FIGS. 1-8. In practice, portions of process of FIGS. 1-8 may be performed by different elements of the described system.

It should be appreciated that process of FIGS. 1-8 may include any number of additional or alternative tasks, the tasks shown in FIGS. 1-8 need not be performed in the illustrated order, and process of the FIGS. 1-8 may be incorporated into a more comprehensive procedure or process having additional functionality not described in detail herein. Moreover, one or more of the tasks shown in FIGS. 1-8 could be omitted from an embodiment of the process shown in FIGS. 1-8 as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments.

It should be understood that various changes can be made in the function and arrangement of elements without departing from the scope of the disclosure as set forth in the appended claims and the legal equivalents thereof.

What is claimed is:

1. A method for piecewise sinusoid trajectory planning, the method comprising:
receiving, by a processing unit disposed in an ego vehicle, point data defining a current path plan for the ego vehicle;
fetching, by the processing unit, a current ego position along the current path plan for a planned trajectory by calculating a velocity and an acceleration for the current ego position which is based in part on a velocity and acceleration derived from a previous planned trajectory;
evaluating the planned trajectory using a cost function derived from a plurality of state variables of the ego vehicle to select each adjacent edge wherein each adjacent edge comprises: a parameterized sinusoid, the planned trajectory is calculated by:
setting, by the processing unit, a path length s of a first node for a current minimum cost solution;
calculating, by the processing unit, a time step (Δt) to ensure the resultant path length if added is less than or equal to a path length resolution wherein the path length resolution is the path length distance between each point defined in the ego vehicle path plan with a change in time t₁ and time t₂ wherein time t₁ is a time at a first node and time t₂ equals a sum of the time t₁ and the time step (Δt);
(A) calculating, by the processing unit, an ego vehicle state at a path position s(t₂), a velocity v(t₂) and an acceleration a(t₂) wherein the path position s(t₂) equals the sum of the path length s and a change of path length (Δs);
(B) fetching, by the processing unit, a set of a plurality of path parameter of friction μ(s), grade θ(s) and curvature k(s);
(C) validating, by the processing unit, a set of a plurality of constraint checks of limits of dynamics and behavior of the ego vehicle;
(D) calculating and integrating, by the processing unit, sub-costs of a discretized cost function for planning the trajectory wherein the sub-costs comprise: time gap error and follow distance error costs between time t₁ and time t₂;
determining, by the processing unit, if the time t₂ is less than a time t_{b} at a second node, if so then setting time t₁ to time t₂ and repeating steps (A) to (D), if not then calculating the sub-costs with a closed form solution of the cost function for entire edge wherein the sub-costs comprise: acceleration error costs for an entire edge; and
calculating, by the processing unit, the total edge costs by summing all the sub-costs wherein the total edge costs comprise: time gap cost, acceleration cost, and follow distance cost.

2. The method of claim 1 further comprising:
creating, by the processing unit, a node grid in a velocity-time domain wherein the node grid comprises: at least one of a first node, at least one of a second node, and at least one of an adjacent edge wherein the first node is coupled to the second node by the adjacent edge wherein the adjacent edge contains a parameterized velocity trajectory sinusoid of a half period to connect the first and second nodes' time and velocities;
resetting, by the processing unit, parameters of the adjacent edge wherein the parameters comprise: a minimum cost and a path length (Δs) of edge; and
resetting, by the processing unit, parameters of the first and second nodes wherein the parameters comprise: minimum cost, parent node, and path length s.

3. The method of claim 2, further comprising:
updating, by the processing unit, the first node with the velocity v(t₀), acceleration a(t₀), and the path position s(t₀) to determine the current minimum cost solution.

4. The method of claim 3, further comprising:
parameterizing and validating, by the processing unit, the adjacent edge for use as a graph edge to determine the current minimum cost path solution.

5. The method of claim 4, further comprising:
executing a shortest path algorithm on a graph of the node grid for a set of items comprising: at least one first node, at least one second node and at least one adjacent edge to calculate a cost for each item of the set based on the current minimum cost solution.

6. The method of claim 5, further comprising:
generating, by the processing unit, an optimal trajectory based on the minimum cost solution and by using a piecewise sinusoidal function to determine the velocity v(t) and acceleration a(t) for the planned trajectory.

7. The method of claim 6, further comprising:
generating, by the processing unit, the cost function which comprises: a total cost function of:
$${J}_{tot} = {J}_{T} + {J}_{a} + {J}_{d} and TG ( t ) = \frac{{s}_{L} ( t ) - s ( t )}{v ( t )} ,$$
each sub-cost function comprises: wherein J_{T}=∫ₜ_{₁}^{t}^{₂}C_{JT}(TG_{des}−TG(t))²dt, Jₐ=∫ₜ_{₁}^{t}^{₂}a(t)²dt=¼C_{Ja}A²ω[2ω(t₂−t₁)+sin(2(ωt₁+ϕ))−sin(2(ωt₂+99 ))] and J_{d}=∫ₜ_{₁}^{t}^{₂}C_{Jd}(d_{soft}−d(t))²dt.

8. The method of claim 7, wherein the cost function comprises: J_{Rem}=∫ₜ_{₂}^{t}^{_{f}}(TG_{des}−TG(t)|_{ν}_{_{F}}_{(t)=ν}_{₂}_{, ν}_{_{L}}_{(t)=ν}_{_{Li}})²dt for a heuristic cost with A* shortest path algorithm wherein ν₂=ν(t₂), s₂=s(t₂), and s_{L2}=s_{L}(t₂).

9. The method of claim 8, wherein the cost function comprises:
$${J}_{Rem} ( {t}_{2} , {t}_{f} ) = ( {t}_{LA} - {t}_{2} ) {( {TG}_{des} - \frac{{s}_{L 2} - {s}_{2} + {t}_{2} ( {v}_{2} - {v}_{Li} )}{{v}_{2}} )}^{2} + \frac{( {t}_{LA}^{3} - {t}_{2}^{3} ) {( {v}_{2} - {v}_{Li} )}^{2}}{3 {v}_{2}^{2}} + \frac{( {t}_{LA}^{2} - {t}_{2}^{2} ) ( {TG}_{des} - \frac{{s}_{L 2} - {s}_{2} + {t}_{2} ( {v}_{2} - {v}_{Li} )}{{v}_{2}} ) ( {v}_{2} - {v}_{Li} )}{{v}_{2}} wherein {v}_{2} = v ( {t}_{2} ) , {s}_{2} = s ( {t}_{2} ) , and {s}_{L 2} = {s}_{L} ( {t}_{2} ) .$$

10. The method of claim 6, wherein for edges connected to the node at t=0, the piecewise sinusoidal function comprises:
$$v ( t ) = A cos ( ω t + φ ) + β , a ( t ) = - A ω sin ( ω t + φ ) and s ( t ) = \frac{A}{ω} sin ( ω t + φ ) + β t + {s}_{1} wherein ω = \frac{π - φ}{{t}_{2}} , A = \frac{{v}_{1} - {v}_{2}}{cos ( φ ) + 1} , β = {v}_{2} + A ,$$
and Φ is iteratively solved for using the equation
$$a ( {t}_{0} ) = \frac{( {v}_{2} - {v}_{1} ) ( π - φ ) tan ( \frac{φ}{2} )}{{t}_{2}} ;$$
and for edges not connected to the node at t=0, the piecewise sinusoidal function comprises:
$$v ( t ) = A cos ( ω t + φ ) + β , a ( t ) = - A ω sin ( ω t + φ ) and s ( t ) = \frac{A}{ω} sin ( ω t + φ ) + β t + {s}_{1} wherein ω = \frac{π}{{t}_{2} - {t}_{1}} , φ = - ω {t}_{1} , A = \frac{{v}_{1} - {v}_{2}}{2} , β = {v}_{2} + A$$
for non-starting edges.

11. A system for piecewise sinusoid trajectory planning comprising:
a processing unit disposed in an ego vehicle comprising one or more processors configured by programming instructions encoded on non-transient computer readable media, the processing unit configured to:
receive point data defining a current path plan for the ego vehicle;
fetch a current ego position along the current path plan for a planned trajectory by a calculated velocity and an acceleration for the current ego position which is based in part on a velocity and acceleration derived from a previous planned trajectory;
evaluate the planned trajectory using a cost function derived from a plurality of state variables of the ego vehicle to select each adjacent edge wherein each adjacent edge comprises: a parameterized sinusoid;
set a path length s of a first node for a current minimum cost solution;
calculate a time step (Δt) to ensure the resultant path length if added is less than or equal to a path length resolution wherein the path length resolution is the path length distance between each point defined in the ego vehicle path plan with a change in time t₁ and time t₂ wherein time t₁ is a time at a first node and time t₂ equals a sum of the time t₁ and the time step (Δt);
(A) calculate an ego vehicle state at a path position s(t₂), a velocity v(t₂) and an acceleration a(t₂) wherein the path position s(t₂) equals the sum of the path length s and a change of path length (Δs);
(B) fetch a set of a plurality of path parameter of friction μ(s), grade θ(s) and curvature k(s);
(C) validate a set of a plurality of constraint checks of limits of dynamics and behavior of the ego vehicle;
(D) calculate and integrate sub-costs of a discretized cost function for planning the trajectory wherein the sub-costs comprise: time gap error and follow distance error costs between time t₁ and time t₂;
determine if the time t₂ is less than a time t_{b} at a second node, if so then setting time t₁ to time t₂ and repeating steps (A) to (D), if not then calculating the sub-costs with a closed form solution of the cost function for entire edge wherein the sub-costs comprise:
acceleration error costs for an entire edge; and
calculate the total edge costs by summing all the sub-costs wherein the total edge costs comprise: time gap cost, acceleration cost, and follow distance cost.

12. The system of claim 11, further comprising:
the processing unit configured to:
create a node grid in a time-velocity domain wherein the node grid comprises: at least one of a first node, at least one of a second node, and at least one of an adjacent edge wherein the first node is coupled to the second node by the adjacent edge;
reset parameters of the adjacent edge wherein the parameters comprise: a minimum cost and a path length (Δs) of edge; and
reset parameters of the first and second nodes wherein the parameters comprise:
minimum cost, parent node, and path length s.

13. The system of claim 12, further comprising:
the processing unit configured to:
update the first node with the velocity v(t₀), acceleration a(t₀), and the path position s(t₀) to determine the current minimum cost solution.

14. The system of claim 13, further comprising:
the processing unit configured to:
parameterize and validate the adjacent edge for use as edges to determine the current minimum cost solution.

15. The system of claim 14, further comprising:
the processing unit configured to:
execute a shortest path algorithm on a graph on the node grid for a set of items which comprises: at least one first node, at least one second node and at least one adjacent edge to calculate a cost for each item of the set based on the current minimum cost solution.

16. The system of claim 15, further comprising:
the processing unit configured to:
generate an optimal path based on the minimum cost solution and by using a piecewise sinusoidal function to determine the velocity v(t) and acceleration a(t) for the planned trajectory.

17. A vehicle, comprising a piecewise sinusoid trajectory planner unit comprising one or more processors and non-transient computer readable media encoded with programming instructions, the piecewise sinusoid trajectory planner unit is configured to:
receive point data defining a current path plan for the ego vehicle;
fetch a current ego position along the current path plan for a planned trajectory by a calculated velocity and an acceleration for the current ego position which is based in part on a velocity and acceleration derived from a previous planned trajectory;
evaluate the planned trajectory using a cost function derived from a plurality of state variables of the ego vehicle to select each adjacent edge wherein each adjacent edge comprises: a parameterized sinusoid;
set a path length s of a first node for a current minimum cost solution;
calculate a time step (Δt) to ensure the resultant path length if added is less than or equal to a path length resolution wherein the path length resolution is the path length distance between each point defined in the ego vehicle path plan with a change in time t₁ and time t₂ wherein time t₁ is a time at a first node and time t₂ equals a sum of the time t₁ and the time step (Δt);
(A) calculate an ego vehicle state at a path position s(t₂), a velocity v(t₂) and an acceleration a(t₂) wherein the path position s(t₂) equals the sum of the path length s and a change of path length (Δs);
(B) fetch a set of a plurality of path parameter of friction μ(s), grade θ(s) and curvature k(s);
(C) validate a set of a plurality of constraint checks of limits of dynamics and behavior of the ego vehicle;
(D) calculate and integrate sub-costs of a discretized cost function for planning the trajectory wherein the sub-costs comprise: time gap error and distance error costs between time t₁ and time t₂;
determine if the time t₂ is less than a time t_{b} at a second node, if so then setting time t₁ to time t₂ and repeating steps (A) to (D), if not then calculating the sub-costs with a closed form solution of the cost function for entire edge wherein the sub-costs comprise: acceleration error costs for an entire edge; and
calculate the total edge costs by summing all the sub-costs wherein the total edge costs comprise: time gap cost, acceleration cost, and follow distance cost.

18. The vehicle of claim 17, further comprising:
the trajectory planner unit is configured to:
create a node grid wherein the node grid comprises: at least one of a first node, at least one of a second node, and at least one of an adjacent edge wherein the first node is coupled to the second node by the adjacent edge;
reset parameters of the adjacent edge wherein the parameters comprise: a minimum cost and a path length (Δs) of edge; and
reset parameters of the first and second nodes wherein the parameters comprise: minimum cost, parent node, and path length s.

19. The vehicle of claim 17, further comprising:
the trajectory planner unit is configured to:
update the first node with the velocity v(t₀), acceleration a(t₀) and the path position s(t₀) to determine the current minimum cost solution.

20. The vehicle of claim 17, further comprising:
the trajectory planner unit is configured to:
parameterize and validate the adjacent edge for use as a graph edge to determine the current minimum cost solution.
